(19) United States
(12) Patent Application Publication
(10) Pub. No.: US 2002/0044069 A1
(43) Pub. Date: Apr. 18, 2002

(54) Microchip-enhanced license plate tab and method

(76) Inventor: Bruce R. Jenkinson, University Place, WA (US)

Correspondence Address: Dean A. Craine, P.S., Suite 140, 400 - 112th Ave. NE., Bellevue, WA, 98004, US

(21) Appl. No.: 09/981,540

(22) Filed: Oct. 17, 2001

Related U.S. Application Data
(60) Provisional application No. 60/241,917, filed on Oct. 18, 2000.

(51) Int. Cl. G08G 1/00

(52) U.S. Cl. 340/928; 340/572.1

(57) ABSTRACT

An improved annual license plate tab affixed to a license plate designed to inform law enforcement personnel if the annual motor vehicle registration period has expired. The tab includes a built-in microchip that store a unique motor vehicle identification code associate with the motor vehicle. The tab includes a transmitter that is activated and transmits the motor vehicle identification code to a wireless receiver operated nearby by law enforcement personnel. The body may also include a bar code or other identification means which enable the law enforcement personnel to quickly access the information. Also disclosed herein is a method of determining the validity of the registration using the above described tab.

This is a utility patent application based on a provisional patent application (Ser. No. 60/241,917) filed on Oct. 18, 2000.

### BACKGROUND OF THE INVENTION

1. Field of the Invention

This invention pertains to the field of automotive data, and more particularly, to license plate tabs and methods of storing automotive registration and related information via microchip and/or bar code.

2. Description of the Related Art

Most states require registered owners of motor vehicles to register their motor vehicles annually or bi-annually. During the registration process, small annual tabs are issued by the state's department of motor vehicle licensing which are adhesively attached in a conspicuous location on the license plate by the registered owner or driver. Law enforcement personnel can review the tab on the license plate to determine whether the motor vehicle has been recently registered. Needless to say, the cost of registration in some states can be relatively expensive and is a major cause non-compliance and theft.

One drawback with the current motor vehicle registration system and tabs is that registration information on record with the department of motor vehicle licensing may not be current. Another drawback is that it requires the law enforcement personnel to be in close proximity to view the tab to determine whether it is current. A third drawback is that it does not prevent theft and can be easily transferred to other license plates attached to non-registered motor vehicles.

### SUMMARY OF THE INVENTION

It is an object of the present invention to provide an improved license plate tab that reduces theft.

It is another object of the present invention to provide such a license plate tab that enables law enforcement personnel to check the validity of the tab from a distance beyond normal vision.

It is a further object of the present invention to provide such a license plate tab that is compatible with current registration systems.

These and other objects of the invention which will become apparent are met by an improved annual license plate tab affixed to a license plate. The tab is given a unique motor vehicle identification code assigned by the authorized regulatory authority with is stored in a microchip imbedded into the tab.

The tab, which may be imbedded directly into the license plate or a separate component adhesively or securely attached to the license plate, includes a continuous or intermittently activated power source which energizes a wireless transmitter to send the motor vehicle identification code to a nearby receiver operated by law enforcement personnel. When the motor vehicle identification code is received by the transmitter, the code is forwarded via a wireless communication link and wide area network to a central computer having access to database files containing all of the motor vehicle registrations in the state. Once the information associated with the code is found on the database files, it is then transmitted to the law enforcement personnel.

In the preferred embodiment, the tab's power source is selectively activated by a radar gun or similar device operated by the law enforcement personnel which transmits a short range signal to a built-in transmitter located in the tab. When the transmitter is sufficiently activated, the microchip automatically causes the motor vehicle identification codes to be transmitted via the transmitter to a receiver located in the law enforcement personnel's motor vehicle. The law enforcement personnel then transmits the information via a wireless communication network to their central computer coupled to the Department of Motor Vehicles Registration database. The desire file is found and then downloaded to the law enforcement personnel who can then take the appropriate action. An important benefit of the system is that it enables law enforcement personal to quickly and easily check registrations from a distance. It also prevents thefts since the tabs can be easily checked by passing law enforcement personnel.

It should be understood that the motor vehicle identification code stored inside the microchip could be displayed as a bar code on the face of the tab so that law enforcement personnel may easily check the status of the registration using a hand bar code scanner.

### BRIEF DESCRIPTION OF THE DRAWINGS

FIG. 1 is a rear elevation view of a motor vehicle found in the prior art having a standard license plate with month and year tabs attached thereto.

FIG. 2 is a front elevational view of the micro-chip enhanced license plate tabs.

FIG. 3 is a sectional side view of the invention taken along lines 3-3 in FIG. 2.

FIG. 4 is a schematic view of the improved license tab shown herein.

FIG. 5 is a diagram showing the components used on the license plate tab.

### DESCRIPTION OF THE PREFERRED EMBODIMENT(S)

Referring to the accompanying FIG. 1, there is shown and described a motor vehicle 8 with a standard license plate 10 used in the prior art. The license plate 10 includes a license plate number 12, and a state name 14 typically molded into the body of the license plate 10. Adhesively attached to the upper left and right comers of the plate 10 is a month indicator tab and a year indicator tab 18, respectively. The tabs 16, 18 inform viewers of the month and year the license plate registration period ends.

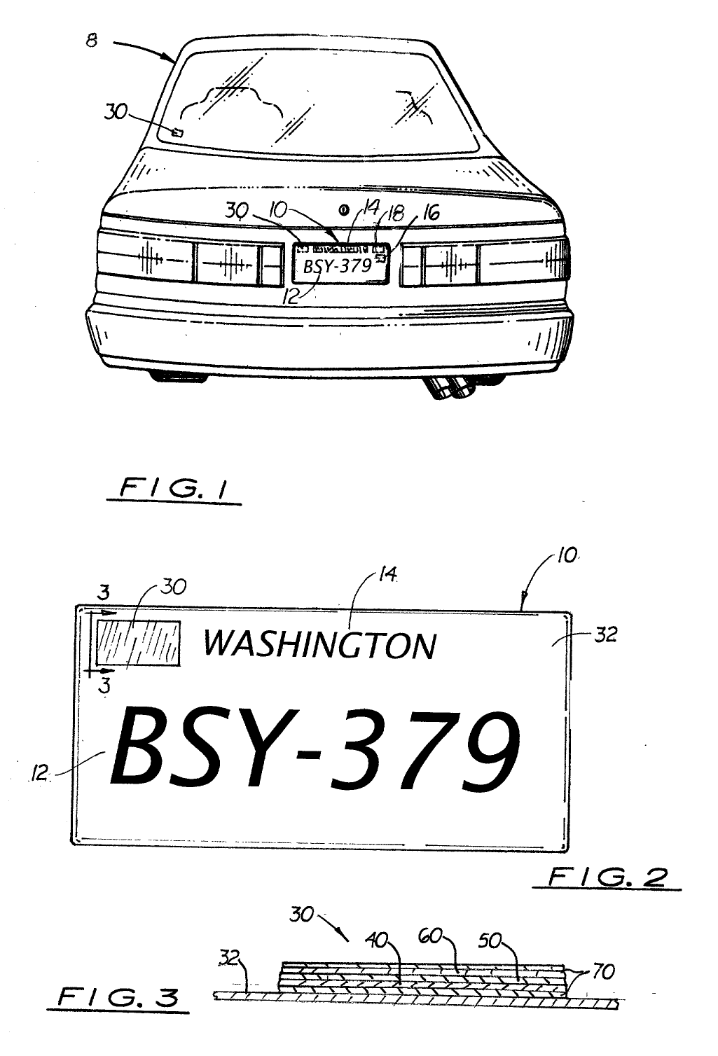

Shown in FIGS. 1-4 is an improved license plate tab 30 affixed via an adhesive layer or constructed into a license plate 10, designed to transmit via a short range, wireless communication link a unique motor vehicle identification number, such as the motor vehicle's VIN, to law enforcement personnel 90 operating a receiver and a computer coupled to a database file. The unique motor vehicle identification number is associated with registration information stored in the computer by the state's Department of Motor Vehicle Licensing when the motor vehicles registration is renewed annually. Using the tab 30 and system, law enforcement personnel 90 are able to quickly and easily obtain updated registration information when moving in traffic or when parked.

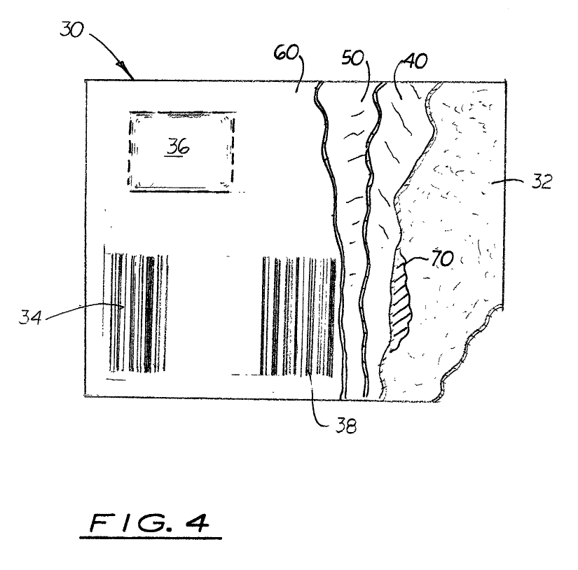

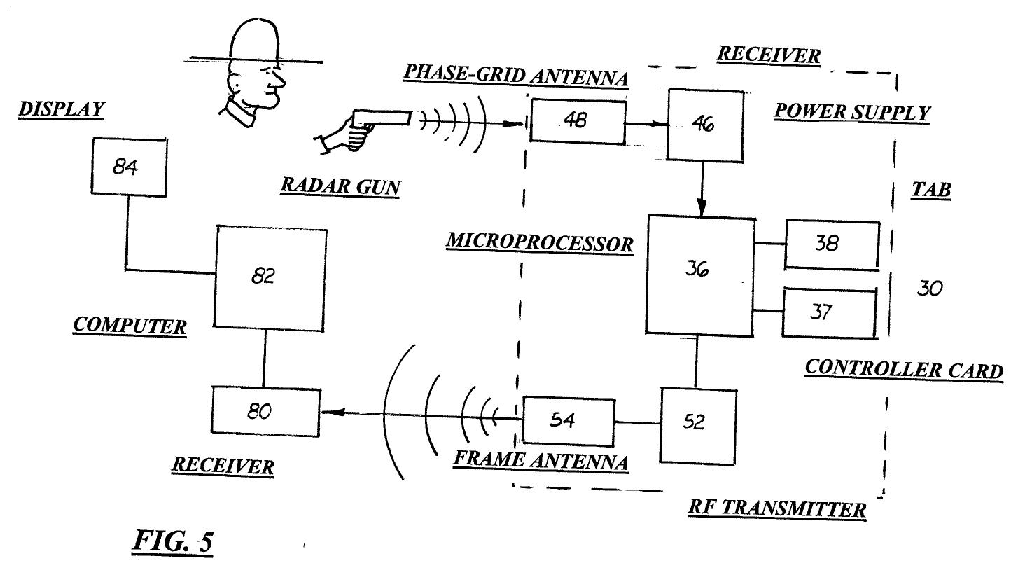

Structurally, the tab 30 is similar to a “smart card” manufactured in a three-layer construction. As shown in FIGS. 3 and 4, the first lower layer 40 includes a built-in microchip connected to a R.F. transmitter 52, and a radar-inducible power supply, also called a transponder 46. The second middle layer 50 consists of a thin, insulated film with two foil-type antennas 48, 54 attached thereto. The first antennae 48 is a phase-grid antennae operating at a frequency of 35 GHz, the same transmission frequency of radar and is connected to the transponder 46. The second antennae 54 has a resonant frequency of 2.5 GHz and is a frame antennae for the R.F. transmitter 52. The third outer layer 60 includes a bar code 34 printed thereon for the unique motor vehicle identification code.

The tab 30 may include an adhesive layer 60 formed over the inside surface of the first inner layer 40 or over the outside surface of the third outer layer 60. If the adhesive layer is formed over the first inner layer 40, the tab 30 may be attached to the front face of a license plate 10 If the adhesive layer 70 is formed over the third outer layer 60, the tab 30 may be attached to the inside surface of a window on the motor vehicle to prevent theft, as shown in FIG. 1.

It should be understood that the R.F. transmitter 52 may be a built-in component or a separate component located in the license plate or some other location in the motor vehicle. It should also be understood that the R.F. transmitter 52 could be a wireless telephone transmitter capable of being used in a wireless telephone network. It should also be understood that the R.F. transmitter could be replaced with a hardwire plug connector.

Operation:

The above tab 30 is designed to be used with current on-line computer systems used by law enforcement personnel. Such systems typically include a computer located inside the law enforcement personnel's motor vehicle which is able to communication via a wireless network to a central computer coupled to a wide area network. The law enforcement personnel's central computer is capable of communicating with computers controlled by the department of motor vehicle licensing so that information on these computer may be selectively downloaded to the law enforcement personnel's central computers.

Each motor vehicle registered owner is required to register his or her motor vehicle and pay an annual registration fee. Each year, the registered owner is given an improved tab described above and instructed to attached the tab 30 to the front face of the license plate or to the inside surface of the rear window of the motor vehicle. When the registration form and fee are submitted, the department of motor vehicle's information is updated and a “paid” indication symbol is entered into the database. When the registration period ends, the registered owner is only required to update his registration information and to pay the annual fee. No new tab is issued unless the original tab is destroyed or damaged.

When the motor vehicle is driven in the region, law enforcement personnel 90 will identify the motor vehicle as having an improved license tab attached to its license plate or rear window. To determine the registered owner or to determine the current status of the registration, the law enforcement personnel selects his or her radar gun 78 and aims it at the license tab 30. A portion of the 35 GHz radar signal is transmitted to the built in phase-grid antennae 481 which causes activation of the transponder 46. When the transponder 46 is activated to a suitable energy level, the microchip 36, the controller card 37 and R. F. transmitter 52 are then activated. The unique motor vehicle code, identified by box 38, is delivered to the R.F. transmitter 52. The controller card 37 then modulates the transmitter's signal which is received by a wireless receiver 80 located in the law enforcement personnel's motor vehicle or PDA. The wireless receiver 80 is coupled to an on-board computer 82 which then transmits the unique motor vehicle identification number 38 to a central computer (not shown) connected to a wide area network and coupled to the Department of Motor Vehicle's database to retrieve and download the desired information.

Using the above described tab, a method of determining the validity of a motor vehicle registration, comprising the following steps:

a. selecting a license tab with a built-in microchip with a unique motor vehicle identification code stored therein, said tab having a transmitter to selectively transmitting the motor vehicle identification code to a compatible receiver;

b. selecting a receiver capable of communicating with said transmitter in said license tab and a central computer coupled to a database file containing specific motor vehicle registration information of a plurality of motor vehicles, each said motor vehicle in said database being assigned to said motor vehicle identification code;

c. attaching said license tab to a motor vehicle;

d. activating said license tab to being transmitting said motor vehicle identification code to said receiver;

e. transmitting said motor vehicle identification code to said central computer;

f. receiving the specific motor vehicle information associated with said motor vehicle identification code; and,

g. reviewing said specific motor vehicle information to determine if the motor vehicle's registration is valid.

In compliance with the statute, the invention described herein has been described in language more or less specific as to structural features. It should be understood, however, that the invention is not limited to the specific features shown, since the means and construction shown, comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An improved license plate tab, comprising:
a. a license plate tab body;
b. a microchip attached to said tab body;
c. a unique motor vehicle identification code stored within said microchip, and;
d. a transmitting means coupled to said microchip used to transmit said motor vehicle identification code to a suitable receiver.

2. The improved license plate tab, as recited in claim 1, further including a receiver coupled to said microchip used to activate said microchip and said transmitter means to transmit said motor vehicle identification code.

3. The improved license plate tab, as recited in claiml, further including visual indicia printed on said tab to indicated the current registration status of said tab.

4. The improved license plate tab, as recited in claim 3, wherein said visual indicia is a bar code.

5. The improved license plate tab, as recited in claim 1, further including means to attach said tab to a license plate.

6. The improved license plate tab, as recited in claim 5, wherein said means to attach said tab to a license plate is an adhesive layer applied to the back surface of the tab.

7. The improved license plate tab, as recited in claim 5, wherein said means to attach said tab to a transparent piece of glass on said motor vehicle.

8. The improved license plate tab, as recited in claim 1, wherein said tab is built into the body of a license plate.

9. A method of determining the validity of a motor vehicle registration, comprising the following steps:
a. selecting a license tab with a built-in microchip with a unique motor vehicle identification code stored therein, said tab having a transmitter to selectively transmitting the motor vehicle identification code to a compatible receiver;
b. selecting a receiver capable of communicating with said transmitter in said license tab and a central computer coupled to a database file containing specific motor vehicle registration information of a plurality of motor vehicles, each said motor vehicle in said database being assigned to said motor vehicle identification code;
c. attaching said license tab to a motor vehicle;
d. activating said license tab to being transmitting said motor vehicle identification code to said receiver;
e. transmitting said motor vehicle identification code to said central computer;
f. receiving the specific motor vehicle information associated with said motor vehicle identification code; and,
g. reviewing said specific motor vehicle information to determine if the motor vehicle's registration is current.
